(19) United States
(12) Patent Application Publication
(10) Pub. No.: US 2021/0041553 A1
(43) Pub. Date: Feb. 11, 2021

(54) EVALUATION METHOD FOR RADAR MEASUREMENT DATA OF A MOBILE RADAR MEASUREMENT SYSTEM

(71) Applicant: ZF Friedrichshafen AG, Friedrichshafen (DE)

(72) Inventors: Martin Randler, Immenstaad (DE); Benjamin Sick, Bodolz (DE); Martin Hermann Hahn, Ebenweiler (DE)

(73) Assignee: ZF Friedrichshafen AG, Friedrichshafen (DE)

(21) Appl. No.: 16/766,589

(22) PCT Filed: Oct. 25, 2018
(86) PCT No.: PCT/EP2018/079255

§ 371 Date: May 22, 2020

(30) Foreign Application Priority Data
Nov. 27, 2017 (DE) 10 2017 221 120.2

(51) Int. Cl. G01S 13/58; G01S 13/34; G01S 13/72; G01S 7/295; G01S 7/35

(52) U.S. Cl. CPC G01S 13/584; G01S 13/34; G01S 7/354; G01S 7/295; G01S 13/726

(57) ABSTRACT

An evaluation method for radar measurement data of a mobile radar measurement system includes the steps of preparing a multidimensional range-Doppler map from the radar measurement data. In this evaluation method, each multidimensional range-Doppler map is stored together with time information. Moreover, at least one multidimensional range-Doppler map with time information is propagated on the basis of known movement data of the radar measurement system to the current time. The multiple multidimensional range-Doppler maps may be combined to form a combined range-Doppler map.

### CROSS-REFERENCE TO RELATED APPLICATION

This application is a national stage of International Application No. PCT/EP2018/079255 filed Oct. 25, 2018, the disclosure of which is incorporated herein by reference in its entirety, and which claimed priority to German Patent Application No. 102017221120.2, filed Nov. 27, 2017, the disclosure of which is incorporated herein by reference in its entirety.

### TECHNICAL FIELD

The present disclosure relates to an evaluation method for a radar measurement system.

### BACKGROUND

There are many different types of radar measurement systems. Such a radar measurement system comprises a transmitting antenna as well as a receiving antenna. The transmitting antenna transmits a radar wave that can be reflected at an object. The reflected radar wave is received by the receiving antenna. When multiple transmitting antenna/receiving antenna pairs are used, measurement data arises for each combination. Range-Doppler maps are established from the measurement data. Such range-Doppler maps show the distance and the speed of objects in the form of measured values with high intensity. The range-Doppler maps are subjected to a method that yields direction, for example a beam-forming method, to determine the direction. Angle-dependent range-Doppler maps, or even multidimensional range-Doppler maps, are prepared in this way. These angle-dependent range-Doppler maps or multidimensional range-Doppler maps are sampled by an algorithm in order to determine local maxima of the measured values that represent the objects. The CFAR algorithm for example is used for this purpose.

Objects that have an intensity below the threshold value of the CFAR algorithm in the angle-dependent or multidimensional range-Doppler maps are not recognized by these known systems.

### SUMMARY

The object is therefore to improve the recognition of weak objects.

This object is achieved by the method as claimed in patent claim 1. Advantageous variants of the method are explained in the dependent claims.

The radar measurement system that is suitable for the method explained further below corresponds inter alia to the explanations regarding the prior art. Such a radar measurement system is in particular designed as a mobile radar measurement system. Such a system can for example be arranged at a vehicle, in particular at a motor vehicle, in order to recognize objects such as for example other vehicles.

The radar measurement system comprises in particular a large number of transmitting antennas and receiving antennas. Advantageously the radar is a frequency modulated continuous wave radar, also known as a FMCW radar. A sawtooth modulation pattern is favorably used.

Each transmitting antenna here transmits radar waves. The sequence of the transmission of the radar waves is distributed over the full set of transmitting antennas. The transmitting antennas for instance transmit in alternating succession, or also simultaneously in an encoded manner, in particular in accordance with the BPSK method. Each receiving antenna can receive each transmitted radar wave, while measurement data are made available for each pair of transmitting antenna and receiving antenna.

These measurement data are evaluated through multiple Fourier transforms, and converted into range-Doppler maps. A range-Doppler map, RDM, corresponds to a respective pair of transmitting antenna and receiving antenna, and while it does comprise the distance of objects and their speed, it does not comprise direction information.

A large number of direction-oriented range-Doppler maps are ascertained from the plurality of RDMs and the knowledge of the arrangement of transmitting antennas and receiving antennas. A beam-forming method that provides range-Doppler maps that consider a specific solid angle is, for example, used for this purpose. The solid angle is specified by a side angle and/or a height angle. Such an angle-dependent range-Doppler map, wRDM, describes through its measured values possible objects that, from the point of view of the radar measurement system, are located in front of it in a specific solid angle.

A high measured value that corresponds to a local maximum represents an object, while its position within the wRDM provides the distance and its speed. In some circumstances, such measured values can be unwanted reflections.

These unwanted reflections can, for example, be generated by side lobes of the radar measurement field.

The large number of wDRMs divide the spatial region under consideration into a large number of solid angles, thereby providing a multidimensional range-Doppler map, mRDM. These mRDMs can for example be 3-dimensional if only one angle is considered, or 4-dimensional if two angles are considered. Actual objects and unwanted objects move within this mRDM assuming that the radar measurement system and the object carry out a relative movement.

Such an mRDM is prepared for each time point at which a measurement is carried out. Each mRDM is saved with its time information or kept ready for a further use. In addition, a movement of the mobile radar measurement system is determined and also kept available to be called up for further use.

On the basis of the known movement of the mobile radar measurement system, this movement can be used for the propagation of the mRDM. An mRDM is referred to for this purpose, and a shift of measured values in the mRDM determined from the known movement The movement data correspond to the movement of the radar measurement system from the time point of the mRDM up to the time point of the current mRDM. The measured values are then accordingly shifted within the mRDM. If an object is static, i.e. is unable to move with respect to the ground, its measured value, i.e. its local maximum, is shifted to the location in the mRDM at which it has to be in a current measurement.

A plurality of mRDMs that were propagated at the same time point are now combined, for example through addition of the measured values. This combined range-Doppler map is also referred to as a zRDM. Static objects are all propagated at this same position in the mRDM and add together for the zRDM to a large measured value that can be detected as a local maximum. Unwanted reflections from side lobes do not move within the mRDM like a static object.

Weak static objects in particular can as a result be ascertained through a subsequent evaluation. If the current mRDM is evaluated alone, these weak static objects would fall under the threshold value for the evaluation algorithm. These static objects, weakly detected by the radar measurement system, can thus be recognized early. Unwanted reflections, in contrast, are averaged out.

A plurality of mRDMs of different time points are preferably used for the zRDM. A current mRDM and a plurality of mRDMs of previous time points can for example be used. In appropriate cases it is also possible for only mRDMs of previous time points to be employed.

Advantageous variant embodiments of the evaluation method are explained below.

It is proposed that the combined range-Doppler map is evaluated with respect to objects.

The zRDM can, for example, be evaluated by means of the constant false alarm rate algorithm, CFAR. Static objects in particular can be ascertained and also tracked better in this way. In addition, static objects that are measured with low intensity can in this way also be detected. The number of determined static objects in the zRDM is accordingly considerably greater than the number of static objects ascertained in an mRDM.

Patterns are particularly advantageously recognized within the measured values by the CFAR algorithm, and tracked over a plurality of cycles of zRDM. Patterns that only change slightly, or not at all, over a plurality of cycles can thus be verified as true objects.

The combined range-Doppler map is advantageously averaged before the evaluation.

An easier assessment of the individual objects is possible in this way, in that the measured values can be better compared.

It is proposed in a further variant embodiment that only those regions at the zRDM that are relevant for static objects are evaluated.

These regions of the zRDM can be ascertained through the known movement. Computing capacity can thereby be saved. The regions are characterized by measured values that are shifted during the propagation.

A radar measurement system that carries out the evaluation method as claimed in one of claims 1 to 5, or at least one of the previous explanations, is also proposed.

This radar measurement system can be designed in accordance with the above explanations or also with the further explanations.

### BRIEF DESCRIPTION OF THE DRAWINGS

The evaluation method, and a radar measurement system suitable for it, are explained below by way of example and extensively with reference to a plurality of figures. Here:

FIG. 1 shows a schematic illustration of a plan view of a mobile radar measurement system and surroundings;

FIG. 2 shows an angle-dependent range-Doppler map of the radar measurement system;

FIG. 3 shows a multidimensional range-Doppler map of the radar measurement system;

FIG. 4 shows the addition of a plurality of multidimensional range-Doppler maps.

### DETAILED DESCRIPTION

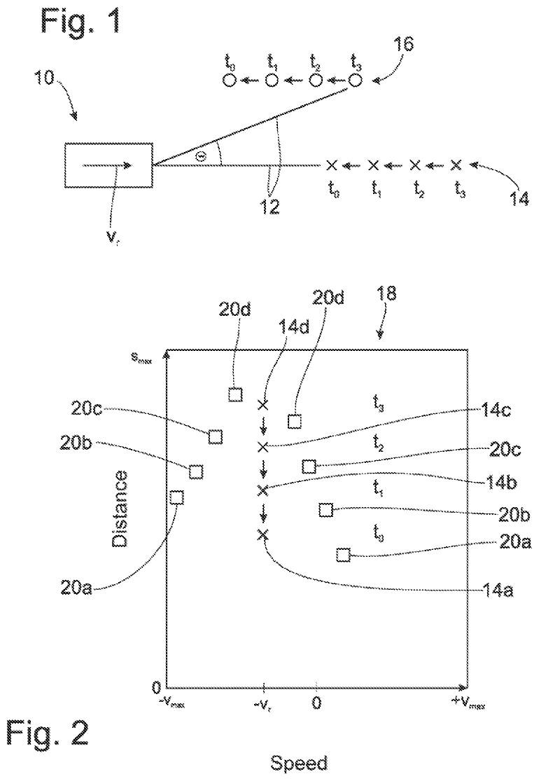

A radar measurement system 10 and surroundings are illustrated in plan view in FIG. 1. The radar measurement system 10 transmits radar waves 12 that can be reflected at objects and can be detected again by the radar measurement system 10. The radar waves 12 are illustrated in a simplified manner as lines. At least one transmitting antenna and at least one receiving antenna are designed for the purpose at the radar measurement system 10. The radar measurement system 10 further comprises a plurality of electronic components in order to enable a transmission and reception of the radar waves and also to be able to process the ascertained measurement data.

Two static objects 14, 16 that are permanently joined to a ground, or that are at least unable to move with respect to it, are located by way of example in the surroundings of the radar measurement system 10. The radar measurement system 10, on the other hand, itself moves with a speed of vᵣ. The radar measurement system 10 is accordingly also referred to as a mobile radar measurement system 10. This can, for example, be arranged at a motor vehicle. In the further explanations, the movement is assumed to be constant and straight. In fact, however, the radar measurement system 10 can execute any arbitrary movement pattern.

This movement of the radar measurement system 10 is known, and is available for the further steps. The motor vehicle can, for example, supply this movement information.

FIG. 1 shows the objects 14, 16 at various time points t₀, t₁, t₂ and t₃. These time points correspond to the time points at which the radar measurement system 10 carries out measurements, and accordingly transmits and receives radar waves 12. The time point to corresponds to the time point of the current measurement, wherein the previous measurement was carried out at the time point etc.

The object 14 is located directly in front of the radar measurement system 10, wherein the location of the object 16 is offset laterally with respect to the object 14. For the purposes of the following explanations, both objects 14, 16 are located at the same height, which corresponds to an unchanging height angle for the radar measurement system 10. The radar waves 12 that are transmitted to the objects 14 and 16 form an angle θ. This angle θ increases with respect to the object 16 as time goes on.

After the transmission of a pulse sequence by the transmitting antennas, the reflection of these pulse sequences at the objects 14, 16, and a subsequent detection by the receiving antennas, range-Doppler maps, RDM, are prepared from the measurement data of the radar measurement system 10. Each RDM corresponds to a transmitting antenna—receiving antenna pair, and comprises a distance and a radial speed of an object with respect to the radar measurement system.

For each angle θ, an angle-dependent range-Doppler map, wRDM is prepared from the ascertained RDM with the aid, for example, of the beam-forming method. Such a wRDM 18 is represented in FIG. 2 for an angle θ=0. The speed is plotted from −vₘₐₓ to +vₘₐₓ on the X-axis. The radial distance from 0 to sₘₐₓ is also shown on the Y-axis. This range of distances and speeds results from the properties of the construction of the radar measurement system 10, and represents the system limits.

A measured value that corresponds to the object 14 is illustrated within this wRDM. Since the object 14 is static, it moves in the wRDM toward the radar measurement system 10 with the speed vᵣ. The object 14 is illustrated with the reference signs 14a, 14b, 14c and 14d at the time points t₀, t₁, t₂ and t₃.

Each object 14a, 14b, 14c and 14d is part of its own wRDM 18 at the time points t₀, t₁, t₂ and t₃. To illustrate the movement of the object 14 these are, however, represented together, i.e. overlaid, in FIG. 2. Since the object 14 is located directly in front of the radar measurement system 10, the angle θ also does not change, so that it always remains within the same wRDM 18.

In addition to objects 14, 16, ghost objects 20 are also generated in the wRDM 18 by the measurement data. These ghost objects 20a, b, c, d are represented for the different time points. These can for example result from unwanted reflections from the side-lobes of the radar measurement system 10. These unwanted reflections can also result from multipath propagation, if a radar wave can propagate along different paths. Interference with other mobile or stationary radar measurement systems can thereby also be averaged out.

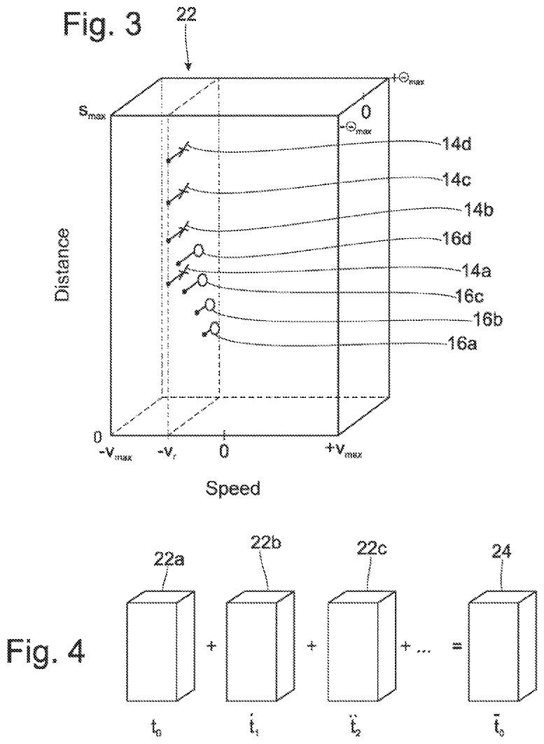

The majority of such wRDMs can be combined into a multidimensional range-Doppler map, mRDM. Such an mRDM 22 is illustrated in FIG. 3. This extends the wRDM by the angle θ from −θₘₐₓ to +θₘₐₓ. The wRDM 18 of FIG. 2 is an element of the mRDM, being central at θ=0.

In addition to the object 14, the object 16 is also drawn in the mRDM for the time points t₀, t₁, t₂ and t₃. The object 16 here moves toward the radar measurement system 10, wherein the radial speed falls and the angle θ rises to −θₘₐₓ.

For the further evaluation according to FIG. 4, a propagation is now carried out for all time points apart from the current time point to. The propagation uses the known movement of the radar measurement system in order to propagate the mRDM, or the respective wRDM, to the time point to. Propagation means that a determination is made as to where an object 14 would be in the form of a measured value from the time point t₁ to the current time point to. Each position within the mRDM is propagated here, wherein only a partial number of all possible positions can comprise static objects. The location at which a measured value must be is also calculated from the time point t₂ to the current time point to, etc. This is here only a straight-line movement, for which reason a shift of the measured values is relatively simple. This method can, in principle, be used for any arbitrary movement pattern. The position of the measured value of the object 14d in the mRDM is thus propagated or shifted to the position of the measured value of the object 14a. The measured values of the objects 14c and 14b are also propagated to the position of the measured value of the object 14a.

Thus according to FIG. 4, a plurality of mRDMs for different time points are propagated to the current time point with the corresponding propagation, and then combined. These mRDMs are given reference signs 22a, 22b, 22c etc. A combined, multidimensional range-Doppler map 24, zRDM is thereby obtained. A mean value can also be determined if appropriate. The number of points beyond the time point t indicates how far the mRDM is propagated. Static objects are always propagated at the same location. Such unwanted reflections, however, behave differently, so that, on the basis of the time points t₀, t₁, t₂ and t₃, they are positioned at different locations in the combined range-Doppler map 24 after the propagation, and thereby average themselves out. Static objects that are submerged in the noise background in the evaluation of one mRDM can thereby nevertheless be ascertained.

The application can be extended to include a height angle in addition to the side angle θ. The way in which it functions is the same here. Due to the difficulty that a 4-dimensional mRDM would represent in a figure, a 3-dimensional mRDM has been used for the explanation.

1. An evaluation method for radar measurement data of a mobile radar measurement system comprising the step of:
preparing a multidimensional range-Doppler map from the radar measurement data,
wherein each multidimensional range-Doppler map prepared is stored together with time information,
wherein at least one multidimensional range-Doppler map with time information is propagated on the basis of known movement data of the radar measurement system to the current time, and
wherein multiple multidimensional range-Doppler maps are combined to form a combined range-Doppler map.

2. The evaluation method as defined in claim 1, wherein the combined range-Doppler map is evaluated with respect to objects.

3. The evaluation method as defined in claim 1, wherein the combined range-Doppler map is evaluated with the aid of the CFAR algorithm.

4. The evaluation method as defined in claim 1, wherein the combined range-Doppler map is averaged before the evaluation.

5. The evaluation method as defined in claim 1 wherein only those regions at the combined range-Doppler map that are relevant for static objects are evaluated.

6. (canceled)

7. The evaluation method as defined in claim 2, wherein the combined range-Doppler map is averaged before the evaluation.

8. The evaluation method as defined in claim 3, wherein the combined range-Doppler map is averaged before the evaluation.

9. The evaluation method as defined in claim 2, wherein the combined range-Doppler map is evaluated with the aid of the CFAR algorithm.

10. The evaluation method as defined in claim 2 wherein only those regions at the combined range-Doppler map that are relevant for static objects are evaluated.

11. The evaluation method as defined in claim 3 wherein only those regions at the combined range-Doppler map that are relevant for static objects are evaluated.

12. The evaluation method as defined in claim 4 wherein only those regions at the combined range-Doppler map that are relevant for static objects are evaluated.
